(19) United States
(12) Patent Application Publication
(10) Pub. No.: US 2022/0270093 A1
(43) Pub. Date: Aug. 25, 2022

(54) SYSTEM AND METHOD FOR DETECTING INTRUSIONS BY RECOGNIZING UNAUTHORIZED CRYPTOCURRENCY TRANSACTIONS AT AN OPTIMIZED COST

(71) Applicant: Bit Trap Pte. Ltd., Singapore (SG)

(72) Inventors: Ariel Futoransky, Martinez (AR); Jonatan Lucas Altszul, Benavidez (AR); Matias Augusto Travizano, San Francisco, CA (US)

(21) Appl. No.: 17/679,064

(22) Filed: Feb. 23, 2022

Related U.S. Application Data
(60) Provisional application No. 63/152,381, filed on Feb. 23, 2021.

(51) Int. Cl. G06Q 20/40; G06Q 20/06; G06Q 20/36; G06Q 20/38

(52) U.S. Cl. CPC G06Q 20/401; G06Q 20/065; G06Q 20/367; G06Q 20/38215; G06Q 20/389; G06Q 2220/00

(57) ABSTRACT

A system and method for detecting intrusions to a set of assets comprising a list of assets identifications, a list of wallet identifications, a register of asset-wallet associations, a bitcoin blockchain, wherein each asset holds a wallet, and wherein wallet identifications include bitcoin live unspent transactions, the method consisting in the steps of: at the publication of every new block of the bitcoin blockchain, checking if one of the live unspent transactions is missing from the list of live unspent transactions included in the new block of the blockchain, and determining whether an intrusion has happened based on the check.

### CROSS-REFERENCE TO RELATED APPLICATIONS

This application claims priority to, and the benefit of, U.S. Provisional Patent Application No. 63/152,381, filed Feb. 23, 2021 and entitled “Method and System for Optimizing Crypto-Bounties for Hackers”, the disclosure of which is incorporated by reference herein in its entirety.

### FIELD OF THE INVENTION

This application relates to computer intrusion detection and in particular to a system and method for creating proper incentives to entice computer hackers to transfer cryptocurrency stored in the assets they compromise, reporting the compromise by identifying the public transfer transaction. This application further relates to optimizing the cost of these incentives.

### BACKGROUND

As people, companies, and other types of organizations depend on their computing infrastructure, it becomes more important to ensure their confidentiality, integrity, and availability, among other security properties. There is, therefore, an inherent value for these people, companies and organizations, to maintain the security of their assets. Here, an asset is considered to be any element of the computing infrastructure, including personal computers, servers, network equipment, virtual machines, and also mailboxes and other forms of Internet accounts holding valuable information.

Computer hacking has become a business and there are a myriad of professionals and hobbyists that profit from hacking into assets, e.g., to steal personal or credit card information, cryptocurrencies, to ask for a ransom, and many other actions (that can be exchanged for currency). When a hacker compromises an asset, he holds a reward expectancy; for example, he may expect to hold the owners of the asset to pay for ransomware, he may want to retrieve credit card information that he can exchange for money at a future date, or there may be some other reward expectancy.

Blockchain-based cryptocurrencies are digital goods. They can be exchanged for services or other goods, including fiat money. Cryptocurrencies include, but are not limited to, Bitcoin (symbol BTC), Ethereum (symbol ETH), XRP (symbol XRP), Litecoin (symbol LTC), Tether (symbol USDT), and forks of Bitcoin like Bitcoin SV. Anyone skilled in the art may list other examples of blockchain-based cryptocurrencies.

In Bitcoin (and also in other cryptocurrencies), an address is the cryptographic hash of a public key belonging to a pubic-key and private-key keypair, or simply a keypair. In the case of Bitcoin, it is a ECDSA (Elliptic Curve Digital Signature Algorithm) key pair.

Bitcoin can be spent by transferring bitcoin from one address to one or more addresses. The private key, associated with an address, is necessary for that transaction: it is used for cryptographically signing the transaction. Each valid transaction is added to a list of transactions in a block of the blockchain.

When bitcoins are spent, a transaction, e.g., transferring the values to another address, is going to be added to the transaction list in one of the blocks in the blockchain. The converse is also true: for any positive amount of bitcoins to be transferred from an address, this address must be included as the origin of a transaction in the list of transactions that is included in a block in the blockchain. Moreover, there is a first block. Every other block is chained to a block it follows.

Whenever a user receives bitcoin (BTC), the transaction is recorded as an UTXO. UTXO stands for Unspent Transaction (TX) Output (sometimes also referred to as ‘unspent transaction’). Every (on-chain) bitcoin transaction sends a number of bitcoin, zero or more, to one or more addresses. Once this happens, the transaction “is spent” and cannot be spent for a second time. The receiving addresses are associated with new unspent transaction outputs that can be spent later. Every block in the ledger contains all the transactions, and it also contains the UTXO Set that holds all the UTXO that remain unspent (for example, this is stored in the $DATADIR/chainstate directory in Bitcoin Core v0.14). The UTXO Set may also be referred to as the chainstate, the chainstate containing a collection of all the UTXO, which are stored in the chainstate data directory of a node. The chainstate updates every time a new block is accepted in the blockchain.

Wallets, or crypto wallets, are used to store private keys. There are several wallet implementations, including software applications or files holding these keys. A wallet should keep the keys (and therefore the cryptocurrency they give access to) safe and accessible.

For other cryptocurrencies (coins) and blockchains one can analogously detect when coins are spent, regardless of the level of anonymity provided by the token-blockchain pair. Hence, detection of a bitcoin unspent transaction being spent can be replaced by an analogous step in other token-blockchain pairs.

A problem with computer hacking, and any form of intrusion, is that it is difficult to detect. Dwell time measures how long hackers hang out in an organization's network before being discovered, [“Attackers' Dwell Time Plummets as Ransomware Hits Continue Faster Detection Is Good News, But More Speed Still Needed”, Mathew J. Schwartz (Mandiant Reports). May 3, 2021]. Studies show that attacker's dwell time is over one month for nearly 80% of the attacks and can grow to over a year for one every ten attacks. The damage inflicted during these attacks is further difficult to estimate but can certainly make a dent in a company's value (e.g., a study by Verizon showed that 60% of small businesses shut down within six months of a major breach.

While many intrusion detection techniques have been designed and are employed, attacks continue to happen. Hacks are often tailored to circumvent whatever new detection technology is being used.

### SUMMARY OF THE INVENTION

A method and system for detecting intrusions by providing incentives in cryptocurrencies that can be detected if transferred, is provided. The method detects intrusions to a set of assets comprising a list of assets identifications, a list of wallet identifications, a register of asset-wallet associations, a bitcoin blockchain, wherein each asset holds a wallet, and wherein wallet identifications include bitcoin live unspent transactions, where the method consists of the steps of: at the publication of every new block of the bitcoin blockchain, checking if one of the live unspent transactions is missing from the list of live unspent transactions included in the new block of the blockchain, and determining whether an intrusion has happened based on the check.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

FIG. 1 is a flowchart illustrating a method of implementing the preferred embodiment of the present invention.

FIG. 2 is a schematic diagram illustrating entities and components that interact as part of the present system and method, including a Wallet Creation Service, an Onboarding Web Application, an Onboarding Service, a Database and the users, hosts and an agent.

FIG. 3A is a flowchart illustrating the first variant to the base case.

FIG. 3B is a schematic diagram illustrating an exemplary wallet having three unspent transactions of S coins each.

FIG. 4 is a flowchart illustrating the second variant to the base case.

FIG. 5 is a flowchart illustrating the third variant to the base case.

FIG. 6 is a flowchart illustrating the fourth variant to the base case.

### DETAILED DESCRIPTION OF THE INVENTION

The present system and method solves the problem of the background of the invention by using an intrusion detection that is agnostic to the attack technique being used, because money is offered to the hacker for him to identify his presence. The hacker is basically receiving an early bonus and can walk away without taking the pains to siphon credit card data or going through the pains of asking for ransom and collecting.

A computer attack may be directed at a person, an organization, company or any collective. Hereafter we use the term organization, for simplicity, to refer to any of the above. An organization may have many members each using one or more assets, examples of assets including, but not limited to, computer hosts, mobile phones, tablets, servers, virtual machines, mailboxes, social network accounts, and other types of infrastructure or Internet accounts. Each of these assets may be valuable to the organization.

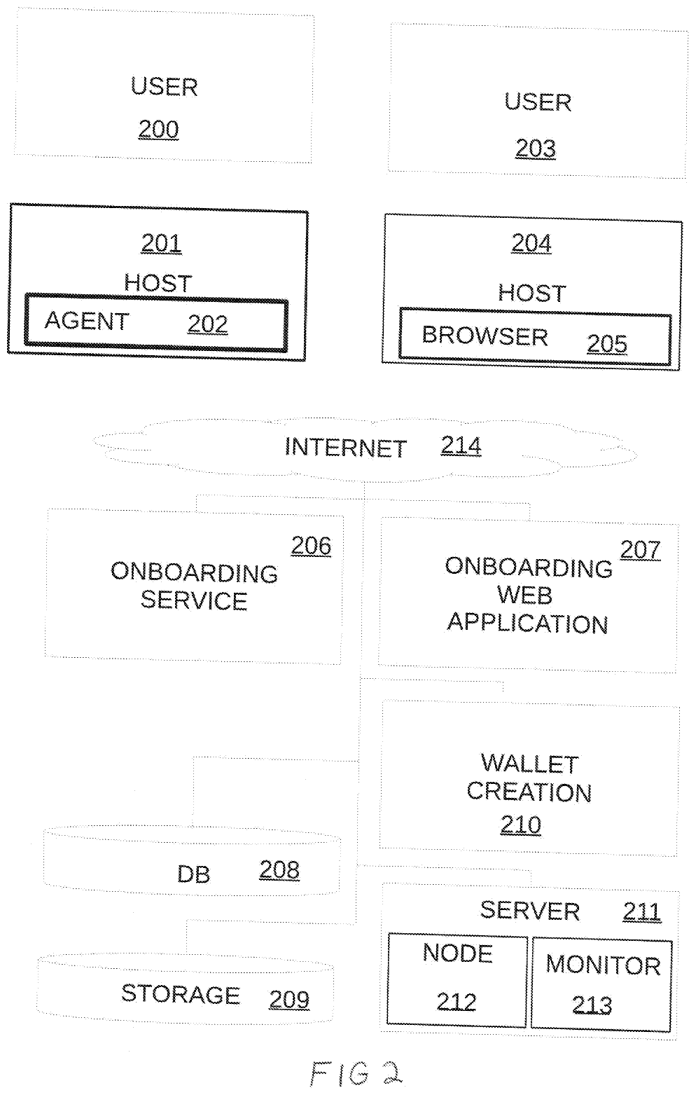

As illustrated by FIG. 2, in an exemplary organization that wants to detect intrusions on two of its assets, these assets being hosts (201 and 204 FIG. 2) which connect to the Internet 214, perhaps through network devices that are not shown for simplicity. Anyone skilled in the art may infer variations of the organization and the assets it holds. Moreover, as it will be seen, the connection to the Internet is unnecessary and is only provided in the example for the sake of simplicity.

A user 200, 203 may be an administrator for the organization, or any person that is granted privileges to perform the steps below, and in particular, to activate intrusion detection in these assets. These users may be granted special access privileges to these assets.

### The Base Case: Wallet Association

In a preferred embodiment of the present invention a set of assets is to be protected. The user is provided with an account allowing access to the different subsystems of the present invention. In particular, the user may register wallet-asset associations as follows.

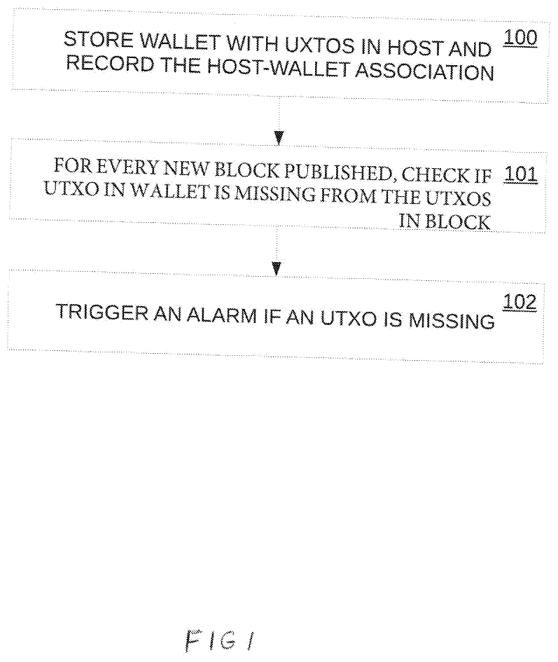

For the purpose of this embodiment, a wallet contains an unspent transaction and the private key necessary for spending this transaction. Wallets may be implemented as files that hold the private keys and unspent transactions. Each of the assets to be protected receives one wallet. Say, the file which implements a wallet is stored within the computer host (asset), or the file implementing the wallet is attached to an email within a email account asset, or the wallet may be an application running in a mobile phone asset. Other forms of putting a wallet in an asset are possible as someone skilled in the art may infer. Within this embodiment, asset-wallet pairs are unique and no wallet (or unspent transaction) is placed in two different assets. The wallet-asset association (or asset-wallet association, the order is irrelevant) contains information identifying each of the members in the pair: (i) the wallet is identified by the address underlying the unspent transaction and may also contain other information, including for example, the key pair or a wallet identifier; (ii) information leading to identification of the asset, including but not limited to a MAC address, an IP address, a mobile phone number (if the asset is a mobile phone). This wallet-asset association is stored in a register. The register may be a table in database (208) or a file in storage (209). Once the wallet is placed in the asset, the association is recorded to be “live” or in the live state. Furthermore, the live UTXOs may be recorded in a live UTXOs register for later use. This is illustrated by step 100 in FIG. 1.

Wallets may be created and placed within assets by a variety of methods. These are not essential to the present invention, however, one example is provided herein.

### The Base Case: Wallet Creation and Deployment (Optional)

The present system and method may contain an Onboarding Service to which the privileged users (200) and (203) have access to. A Wallet Creation Service (210) is charged with producing wallets. We assume it is funded; meaning that whenever it requires one fraction of a bitcoin, it has access to this currency.

The Wallet Creation Service (210) receives an integer, say N, and creates N wallets. (It may optionally allow users to define what type of wallets they want to generate in case that more than one type is available, e.g., mobile application or file.) It may further receive a second integer S that stands for the number of satoshi (satoshi is the smallest bitcoin unit, standing for 0.00000001 bitcoins) to be placed in each wallet. An underlying procedure creates N bitcoin keypairs and the corresponding addresses in the Bitcoin blockchain, transfers S satoshi to each address, and generates N wallets, each holding one UTXO and the associated keypair. There are many variations and alternatives that can be implemented by someone skilled in the art, including having wallets hold more than one address or unspent transaction adding up to S satoshi, or each wallet holding different values. Hereafter we shall use the term coins instead of satoshis. One coin may stand for one satoshi, but more generally for any other token.

In particular, the wallet includes the cryptographic key or elements required to use the coins within the wallet, e.g., transfer them to another address.

All wallets generated are uniquely identified within the wallet creation service (210), e.g, with an arbitrary identification number. This information is stored in a register that can be accessed by the system at any given time, e.g., tables in a database (208) or storage (209). These wallets are marked as unused in the register, because, by design, it is noted that none of these addresses has been used.

A user (200) from the organization can install a software agent (202) in host (201). When the agent loads, it asks the user (200) for authentication credentials. The agent communicates with an API (Application Programming Interface) exposed by the Onboarding Service (206), authenticates the user (200), and offers to the user (200) a file implementing a wallet marked as unused. The agent further gathers information identifying the host it is running on. In order to connect to these services, the agent may use the connection that the host has to the Internet (214); as another option, the agent and services may be hosted in a private network; the user may enter this information manually; or the transmission may happen offline.

Alternatively, a second user (203) commanding a second host (204) can interact with a Web Application (207) exposed by the Onboarding Service (206) through a web browser (205) running in the host (204). Analogously, the web application (207) authenticates the user with the Onboarding Service and offers to the user (203) a file for an unused wallet. The web application (207) further identifies the host (204) where the browser (205) is being executed and relays host information (identifying the host) it gathers to the Onboarding Service (206).

In both cases the Onboarding Service (206) produces the unused wallets by connecting to the wallet creation service. Once a wallet is made available to the agent (202), the agent downloads and stores it in a predefined folder in the filesystem of host (201), for example, a Folder called “Cryptos” in the home directory for a user of the host. If the host requires specific credentials for this step, the credentials are obtained by the user agent implementing steps known by anyone skilled in the art.

Respectively, the Onboarding Web Application (207) can offer the user (203) to download the file and provide instructions for the user to save the file in the predefined directory of host (204). Host (or more generally asset) identification may be done by the agent or via the browser; alternatively, these may expose a form so that users (200) or (203) may fill in this information manually.

In both cases, when a wallet is obtained from the wallet creation service 210, it is marked as live (or used) and the wallet-asset association is recorded in a register. Also, the underlying UTXO is marked as live and is made part of the live UTXTOs register, e.g., in the database (208).

Note that the same user or different users for one organization, can repeat this process from two or more hosts obtaining different wallets each time, and the service registering each of the associations, at least until all the wallets available for the organization have been used.

By an asset receiving a wallet, or placing a wallet in an asset, we mean that the wallet is made available to that controlling the asset, an example including, but not limiting to (a) the asset is a computer and the wallet is a file that is stored in the computer's storage, or (b) the asset is a computer and the wallet is an application that is installed or runs in the computer, or (c) the asset is a mailbox, the wallet is a file and it is attached to an email in that mailbox.

### The Base Case: UTXO Scanning

A UTXO Scanning Procedure runs periodically, e.g., within the monitor application (213) in server (211), in the preferred embodiment of the present invention. Each time a new block is published, this procedure checks if any of the live UTXOs (i.e., any of the UTXOs for live wallets or live wallet-asset associations) is missing.

For example, a bitcoin node (212), which may be a full node, light node or any other which obtains the UTXO Set on every block refresh, runs in server (211). Every time a new block is published, a monitoring procedure (213) reads the list of all the unspent transactions (e.g., the UTXO set) checking if any of the live UTXOs is missing. This is part of the chainstate in Bitcoin (see, e.g., the bitcoin documentation https://developer.bitcoin.org/reference/). If any live UTXO is missing, an intrusion alarm is triggered and the Intrusion Analysis Procedure is run with the missing UTXO or UTXOs as input. This amounts to step 101 in the flowchart of FIG. 1.

Alternatively, the UTXO Scanning Procedure may use other means of checking if any of the UTXOs in the Live UTXOs set is missing. Moreover, the procedure may check if there are any new transactions with the addresses underlying the Live UTXOs as source, say, in any bitcoin block explorer. If there were more than one missing UTXO, then the procedure is repeated for each case.

### The Base Ease: Detecting Intrusions

When the Intrusion Analysis Procedure, for example, running as part of the monitor 213, receives as input at least one UTXO, the intrusion analysis procedure looks up in the asset-wallet associations register (e.g., database 207), which of the wallets includes the missing UTXO and then returns the wallet-asset association for this wallet. In the preferred embodiment of the present invention, every UTXO (or address) is in only one wallet. The procedure then outputs the association with the live UTXO and in particular, the information identifying the asset in the association. This amounts to step 103 in the flowchart of FIG. 1. This asset must have been compromised. This is because the fact that the UTXO has been spent means that someone got ahold of the wallet, which is only stored within the said asset. (The alternative is that the cryptographic algorithm underlying bitcoin has been broken, which is highly unlikely and if it happened then every bitcoin could be stolen. A second alternative would be that some other copy of the wallet has been compromised, but the invention ensures there are at most two copies: one in the said asset, and there is potentially a second copy which is safeguarded by the Wallet Creation Service or an analogous subsystem.) If we go by the first assumption and assume that someone got ahold of the wallet, then the only way this may happen is if someone compromised the asset which includes the wallet.

### The Base Case: Defining the Bounty

The currency available in a wallet (e.g., the integer S in the above example) is called the bounty. The bounty amount needs to be defined so that a hacker, compromising an asset, is lured into cashing the bounty without carrying further actions. We call that value the preferred bounty. In one embodiment of the present invention, the preferred bounty is computed by:
Selecting an initial bounty estimate E, for example coins worth one thousand US dollars
Creating wallets with slight perturbations of E; for example by adding or removing a small percentage of E, say, E plus ten percent (say, coins worth one thousand one hundred US dollars), E minus ten percent (say, coins worth nine hundred US dollars), et cetera.
Using these wallets according to the preferred embodiment of the present invention and recording what assets are compromised with the method triggering an alarm, and which are compromised and an intrusion is detected through other means (e.g., because the hacker asks for ransomware).
Determining the preferred bounty by a formulae on these values; for example, the minimum of the bounties that were collected, or the tenth percentile, or any other statistical parameter on these values.

In a variation of the above bounty-computation method, the assets are replaced by computer hosts that are intentionally vulnerable and accessible from the Internet. This is a standard procedure for someone skilled in the art, and can be achieved, for example, by deploying hosts in the Amazon EC2 service that have an unpatched operating system or unpatched services.

In yet another variation of the bounty-computation method, the preferred bounty is computed by aggregating the information on security incidents that are input manually. This information may include data breaches surveys, the prices paid in ransomware attacks (and the characteristics of the victim including their industry, technology stack and security strategy). For example, the preferred bounty can be set to the average ransomware paid last year, or take into account the expected return calculated using the percentage of paid ransom, or create more sophisticated models using machine learning and the parameters available.

### Alternatives to the Base Case

In the base case, in order to detect the compromise of N assets, each holding a wallet with S coins, the method requires first obtaining S*N coins and maintaining these in wallets within the preselected assets. So that as the number S*N grows, it becomes inconvenient for their owner. Embodiments of the present invention solve this problem in different ways.

### First Set of Variants to the Base Case

According to this embodiment of the present invention, the system and method is set to detect intrusions in N assets. Assume given M, S and F positive integers, with F smaller than M, as input.

In this alternative embodiment of the present invention, each wallet is generated containing F unspent transactions of S coins each (plus the associated private keys) so that no two wallets have exactly the same UTXOs. Whenever an UTXO is used for one wallet, the UTXO is marked as live in the register (if it was already live, nothing happens). The asset-wallet associations are registered as before.

These may be generated, for example, via a modified Wallet Creation Service (210) which first creates M unspent transactions of S coins each (block 251). Then, it creates N wallets, each consisting of F unspent transactions of S coins each, wherein each wallet is created by randomly selecting F unspent transactions without substitution from the set of MUTXOs (block 253). Random drawing is standard practice in probability theory, and exemplary description being provided in, “An Introduction to Probability Theory and Its Applications”, Vol. 1, by William Feller (ISBN-10: 0471257087), which is incorporated herein in its entirety. Each wallet, thus holds S * F coins (S times F). Next, the Wallet Creation Service continues by adding to each wallet the private keys associated with each of the UTXOs included therein, and finally recording in a register (e.g., a table in database 208 or storage 209) an identification number for each wallet, the unspent transactions associated with it, and possibly the key pairs as well. Again, when the Onboarding Service (207) is called by an authenticated user, it returns one such wallet and records the wallet—asset association. Here the wallet is marked as live, same as before.

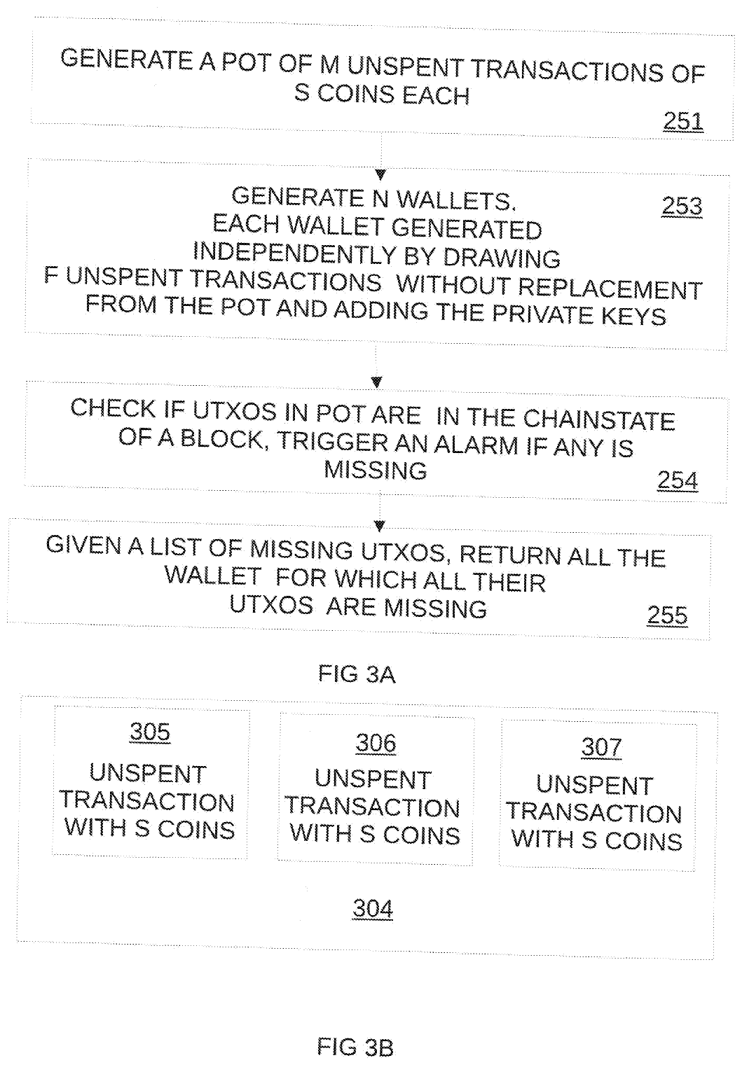

An exemplary wallet (304) with F=3 unspent transactions (305, 306, 307) of S coins is depicted in FIG. 3B. According to this example, to get 20 coins in three wallets we may use two unspent transactions of 10 coins each; say we label UTXOs as a, b and c and generate a wallet with a and b and a second wallet with b and c, and a third wallet with a and c. In this way we have F=2 and M=N=3 and S=10: we used 30 coins but generated three different wallets whose contents add up to 20+20+20=60 coins.

According to this embodiment, the UTXO Scanning Procedure within the monitor 212 runs on every published block checking whether any of the live UXTOs is missing (i.e., if an UTXO has been spent) (block 254). Each live UTXO that has gone missing is recorded as missing. Whenever there is a new missing UTXO, the Intrusion Analysis Procedure is called and evaluates whether the alarm criterion is met. The alarm criterion for a wallet is that all of its F different UTXOs are in the missing UTXOs set. If the alarm criterion is met, the asset is detected as compromised and an alarm is triggered (block 255). For example, the procedure can loop over all the wallets verifying if all the addresses in it are also in the missing UTXO list.

Returning to the above example, discovering that UTXOs a and c have gone missing would point to the third wallet and the Intrusion Analysis Procedure would return the asset-wallet pair associated to the third wallet.

Alternatively, a different alarm criterion could be used. For example, the criterion is met if, say, at least 90% of the UTXOs in a wallet are also in the missing UTXO list. Other thresholds can be considered as well. This is depicted in FIG. 3A. Specifically, the flowchart of FIG. 3A reads that a first step is to generate a pot of M unspent transactions of S coins each (block 251) after which there is a generating of N collections, where each collection is generated independently by drawing F unspent transactions without replacement from the pot (block 252). From each collection a wallet is constructed by putting together the UXTOs in the collection plus the private keys for these UTXOs.

### Variants

Detection by the Intrusion Analysis Procedure need not be perfectly accurate when the threshold is lowered: the procedure could detect an asset as compromised, when it was not (a false positive), and one could fail to detect that an asset was compromised (false negative).

Given a pair of wallets, each holding F unspent transactions, the number of collisions between them is defined as the size of the intersection of the two sets of unspent transactions. (Returning to the above example, the first wallet with unspent transactions a and b and the second wallet with unspent transactions b and c have one collision.) More generally, given at least two wallets, the number of collisions between them is defined as the maximum number of pair-wise collisions.

A first variant of this embodiment introduces a new parameter K. The Wallet Creation Service (procedure) is modified as follows. Repeat K times the step of randomly drawing F unspent transactions N times from the pot (the pot is the set ofMunspent transactions of S coins each), compute the number of collisions, and record each attempt. Finally, return the random drawing attempt with the smallest number of collisions. Use this random drawing (as opposed to the first and only attempt) by generating the wallets according to this distribution.

A second variant of this embodiment adds the parameters F and L. According to this method, the Wallet Creation Service of the base case is modified as follows. First selecting F unspent transactions without substitution from the pot and associating these to a first wallet and adding this wallet to a wallet-to-UTXOs association table. Next, recursively repeating this step until the list of generated wallets has size N the following step: randomly draw F unspent transactions without substitution from the pot, if the number of collisions between this wallet and the ones already selected (and registered in the wallet-to-UTXOs association table) is smaller than L, add this wallet to the table; else, repeat this step.

In the second variant, the parameter L can be provided as an input or it can be selected as the biggest L′ such that C(M−L′+1, F)′ is bigger than N.

Using the first or second variants, S * M coins are spent to generate N wallets with S * F coins. For example, to protect N=10 assets, having M=5 unspent transactions of S=1 coins and setting F=3 we have that 10 assets are protected with 3 coins in each but only 5 coins are used (instead of the 30 coins that demands the base case).

In the second variant, if a hacker compromises at most L assets and spends all of the unspent transactions included, then we can detect which are the assets he compromised. For example, if L=0 and the hacker compromises one asset, then we can detect that a wallet was compromised but may fail to detect which was this asset since there could be two wallets with exactly the same coins. Similarly, if L=5 and the hacker compromises one asset, spending 6 For any pair of positive integers, n, k we let C(n, k) denote the combinatorial number denoting the number of combinations of n things taken k at a time without repetition. This is standard notation in Probability Theory. transactions included therein, then we can detect which is the compromised asset, but may fail to do so if he spends only five or less, as these transactions could repeat in several assets.

As an example, when there are N=48 wallets, each having F=6 unspent transactions of S=100 coins each and set M=8 as the total number of unspent transactions generated. Then, M*S=8*100=800 coins are used. Since selecting L=1 produces C(M−L+1, F)=C(8−1+1, 5)=56 is bigger than N=48, we can set L=1 and generate the N=48 wallets such that any wallet differs with any of the others in at least one of the unspent transactions. Thus, spending 800 coins the 48 assets are covered; otherwise it could have taken 48*6*100=28,800 coins.

### Second Set of Variants to the Base Case

In a second embodiment of the present invention we introduce a variation of the base case as follows. Let us be given parameters Nand S, and an unspent transaction of S coins. Let us call this the first unspent transaction.

According to this embodiment of the invention N wallets are generated. Each wallet consists of two UTXOs and a private key, the pair consists of the first unspent transaction plus a second unspent transaction (one second unspent transaction per wallet) using the first unspent transaction and transferring these S coins to a new address. We may also refer to this pair as a collection. The pair of UTXOs and the private key for the second unspent transaction are added to the wallet, and wallets may be generated one by one. When the wallet is recorded, both UTXOs and private key are stored.

Once they are placed in an asset, the wallet-asset association is recorded and marked as live—as before. This may be implemented via variations of the Wallet Creation and Onboarding Service mutatis mutandis.

The UTXO Scanning Procedure and Incident Triggering Procedure are modified so that the UTXO Scanning procedure detects if both of the UTXO in one of the pairs are missing, and detects the asset associated to the pair as compromised if this happens.

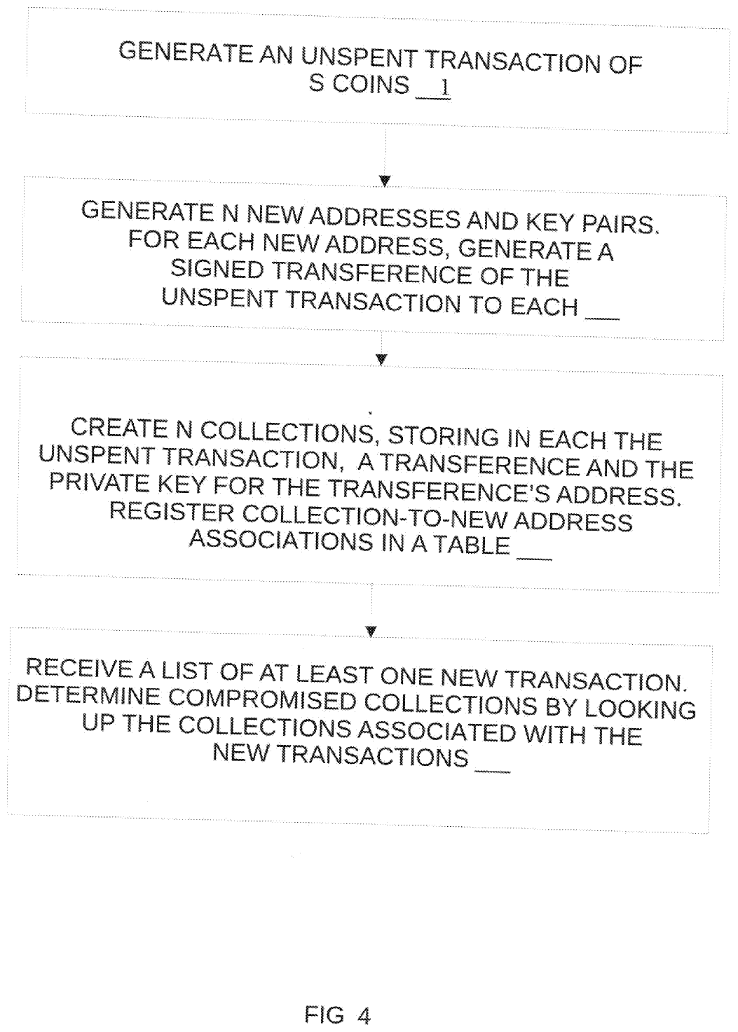

This is depicted in the flowchart of FIG. 4. The flowchart of FIG. 4 explains that there is first a generation of unspent transaction of S coins (block 271), after which there is a generating of N new addresses and key pairs. For each new address, there is a generation of a signed transference of the unspent transaction to each (block 272). As shown by block 275, there is then a creation of N collections, storing in each the unspent transaction, a transference, and the private key for the transference's address. Collection-to-new address associations are then registered in a table (block 275). This is analogous to wallet-address associations, and they can be used interchangeably.

### Discussion

Evidently, this embodiment only requires S coins but, on the flipside, helps only in detecting the first intrusion. Once any of the UTXOs is used, the remaining UTXOs have no value as double-spending is not possible in the Bitcoin network.

### Third Set of Variants to the Base Case

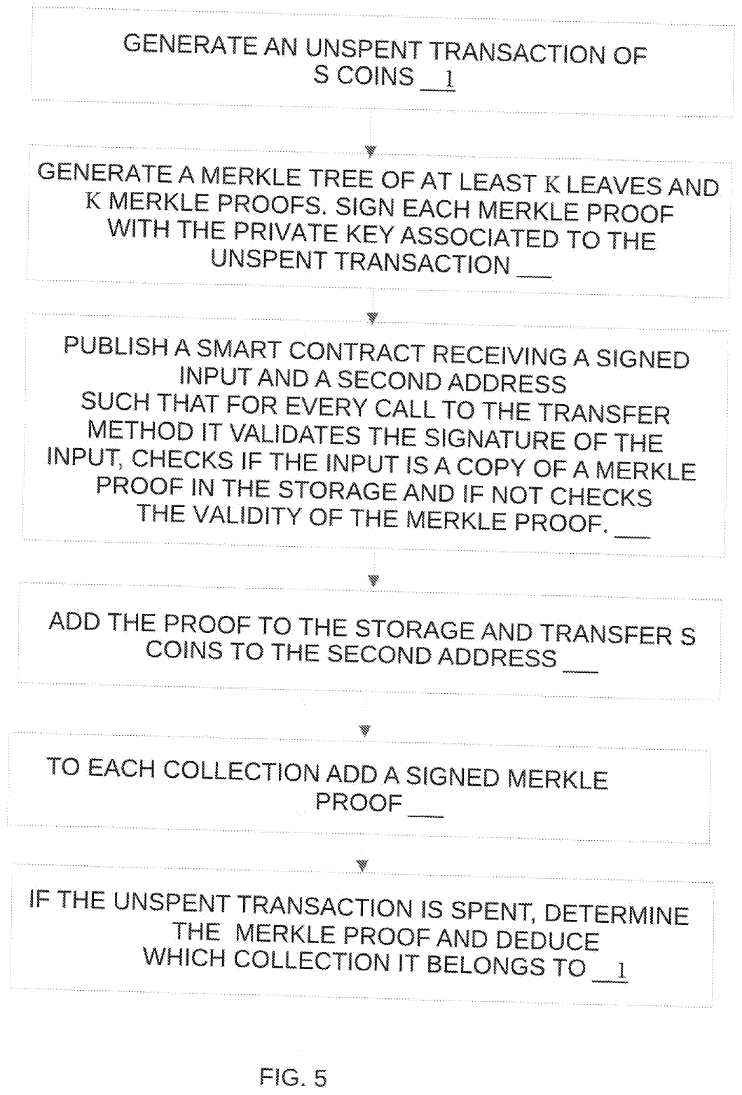

As illustrated by the flowchart of FIG. 5, in a third embodiment of the present invention the system and method is used to detect intrusions in N assets and receives an unspent transaction of S coins.

Let k denote the smallest integer bigger than the base 2 logarithm of N; in symbols we write k=CEILING(log2(N)). Let us be given a merkle tree of depth k using a preferred hash function, say SHA3, and N merkle proofs (for N of its leaves). Merkle trees and Merkle proofs are standard knowledge in Cryptography, see for example, “Programming Bitcoin: Learn How to Program Bitcoin from Scratch”, by Jimmy Song from O'Reilly, which is incorporated by reference herein in its entirety. Let us be given N wallets, each wallet holding the address of a smart contact, a (different) merkle proof and its signature using the prespecified address/key pair.

Assume that a bitcoin smart contract is deployed implementing the following method. The method receives a signed transaction and a target address. If the transaction's signature is validated with respect to the prespecified public key, and the transaction includes a merkle proof, the method: checks if the merkel proof is not in the smart contract's storage, and exits if the proof is correct. If both conditions are satisfied, the smart contract transfers S coins to the target address and copies the merkle proof to the storage. If either the merkle proof was already in storage, or if the proof validation fails, it does nothing. Assume further that the smart contract is funded with a supply of at least S coins.

Referring to FIG. 5, for further elaboration, there is a generating of an unspent transaction of S coins (block 281). A merkle tree is generated of at least k leaves, and N merkle proofs are also generated. Each merkle proof is signed with a private key associated to the unspent transaction (block 283). As shown by block 285, the system and method then publishes a smart contract receiving a signed input and a second address such that for every call to the transfer method it validates the signature of the input, checks if the input is a copy of a merkle proof in the storage and if not checks the validity of the merkle proof, the system and method then adds the proof to the storage and transfers S coins to the second address (block 287), after which, to each collections, a signed merkle proof is added. If the unspent transaction is spent, a determination is made of the storage of the smart contract to determine which merkle proofs were added and a deduction is made regarding which collection (or wallet) it belongs to.

The Wallet Creation and Onboarding Service may be modified to create the merkle proofs, deploy the smart contract, and transfer funds to this smart contract. In any case, when a wallet is placed in an asset, the association asset-wallet is registered and the wallet is marked as live.

The UTXO Scanning procedure of the base case is used. Having only one unspent transaction, the procedure checks if this UTXO is missing. When this happens, it calls the Intrusion Analysis procedure that checks the smart contract's storage, determines which of the merkle proofs has been recorded in the storage and what asset is associated with this merkle proof in the asset-wallet associations register. The procedure then outputs this asset's identification.

### Discussion

According to this embodiment, whenever a hacker captures one of the wallets, in order to transfer the coins to one of his accounts, he must execute the smart contract with the signed merkle proof as input. Hence, the merkle proof is added to the storage of the smart contract and therefore, the contract owner can determine which wallet did the hacker access only from the public information. This is because the smart contract and its storage are public.

Also note that the smart contract need only hold S coins at the start in order to operate. If these coins are spent, the user can add more coins reactively (e.g., via the Wallet Creation Service). In this way, at most S coins are locked at each time. Furthermore, the owner can decide to pause or stop the contract at any given time.

### Fourth Set of Variants to the Base Case

Another embodiment of the present invention makes use of multi-signatures. In Cryptography, an m-of-n multi-signature is a mechanism that allows any m out of n predefined keys to sign a transaction. For example, a 2-of-2 mechanism requires two out of two signers available to sign a transaction, and a 1-of-6 multisignature allows anyone of 6 key owners to sign a transaction. In these cases the 2 (respectively 6) signers hold a private key and they may opt to sign a message at any time; if a message has been signed by 2 (respectively 6) signers, then anyone holding the public keys may determine the message signature to be valid. Public keys are available in the Bitcoin blockchain. An example of this is provided at the URL location https://en.bitcoin.it/wiki/Multi-signature, the contents of which are incorporated by reference in their entirety.

In bitcoin, in particular, the maximum number n available for a 1-of-n signature may change and depends on how this is implemented. Other crypto-currencies allow for multi-signature. So, let us assume a crypto-currency is fixed and let M be the maximum number such that 1-of-M multi-signatures are allowed with this crypto-currency.

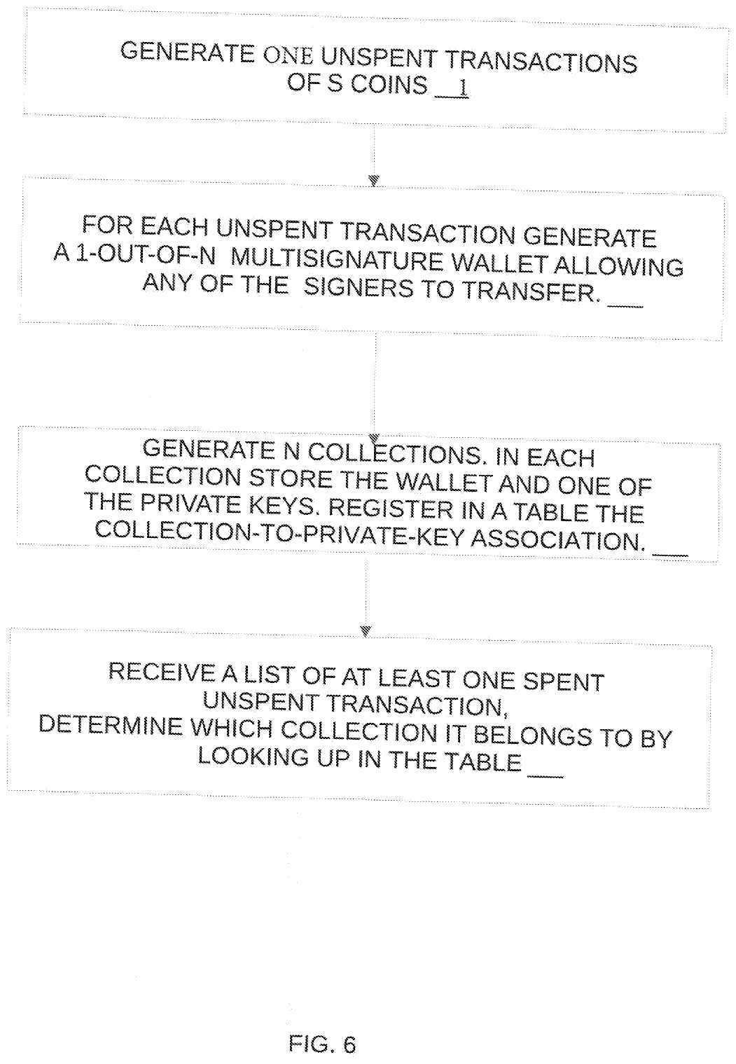

The Wallet Creation Service procedure according to this embodiment works as follows, and as illustrated by the flowchart of FIG. 6. Again, we assume we want to detect intrusions in N hosts, and let S be a parameter. The procedure thus generates N wallets. If N is smaller than or equal to M, then the procedure generates N key pairs and an unspent transaction with a 1-of-N signature for these key pairs. This is shown by block 371.

Otherwise, the procedure divides the assets into groups of at most M items, e.g., it generates m groups where m=CEILING(N/M) is the minimum integer bigger than N/M, and for each of these groups it generates one key pair per asset and an unspent transaction allowing any of the 1-of-N private-key owners to spend (block 373). The procedure next creates N wallets adding to each wallet a key pair and the underlying unspent transaction (block 375). Wallet-asset pairs are registered in a table. All these UXTOs are then registered as live.

The Onboarding Service and Onboarding Web Application thus allow an authenticated user to retrieve one of these wallets to place it in an asset, record the wallet-asset association, and register this unspent transaction as live.

The UTXO Scanning procedure checks if any of the live UTXO (for example, created by the Wallet Creation Service) is missing whenever a new block is published. If this happens, the Intrusion Analysis procedure triggers, it checks which is the unspent transaction that has gone missing and what is the key pair used to spend it. With this information the procedure checks the table and determines what is the wallet with this key pair and what is the asset associated with this wallet. The procedure then outputs the identification for this asset.

In this embodiment, for the cost of m*S=CEILING(N/M)*S coins, N assets are protected with each asset containing a bounty of S coins. Clearly, if M>1 we have that m*S is smaller than N*S. Hence this optimizes over the base case.

It should be noted that the server may be one or more computers, and the onboarding service, onboarding web application, and wallet creation service may be provided within a computer, an example of which is described herein. The computer contains a processor, a storage device, a memory having software stored therein that defines the abovementioned functionality, input and output (I/0) devices (or peripherals), and a local bus, or local interface allowing for communication within the computer. The local interface can be, for example, but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor is a hardware device for executing software, particularly that stored in the memory. The processor can be any custom made or commercially available single core or multi-core processor, a central processing unit (CPU), an auxiliary processor among several processors associated with the present system, a semiconductor based microprocessor (in the form of a microchip or chip set), a macroprocessor, or generally any device for executing software instructions.

The memory can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory may incorporate electronic, magnetic, optical, and/or other types of storage media. Note that the memory can have a distributed architecture, where various components are situated remotely from one another, but can be accessed by the processor.

The software defines functionality performed by the microscope control computer, in accordance with the present invention. The software in the memory may include one or more separate programs, each of which contains an ordered listing of executable instructions for implementing logical functions of the computer, as previously described. The memory may contain an operating system (O/S). The operating system essentially controls the execution of programs within the computer and provides scheduling, input-output control, file and data management, memory management, and communication control and related services.

The I/O devices may include input devices, for example but not limited to, a keyboard, mouse, scanner, microphone, etc. Furthermore, the I/O devices may also include output devices, for example but not limited to, a printer, display, etc. Finally, the I/0 devices may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the computer is in operation, the processor is configured to execute the software stored within the memory, to communicate data to and from the memory, and to generally control operations of the computer pursuant to the software, as explained above.

When the functionality of the computer is in operation, the processor is configured to execute the software stored within the memory, to communicate data to and from the memory, and to generally control operations of the platform pursuant to the software. The operating system is read by the processor, perhaps buffered within the processor, and then executed.

When the present system is implemented in software, it should be noted that instructions for implementing the system can be stored on any computer-readable medium for use by or in connection with any computer-related device, system, or method. Such a computer-readable medium may, in some embodiments, correspond to either or both the memory or the storage device. For purposes of illustration,

In the context of this document, a computer-readable medium is an electronic, magnetic, optical, or other physical device or means that can contain or store a computer program for use by or in connection with a computer-related device, system, or method. Instructions for implementing the intelligent acquisition system can be embodied in any computer-readable medium for use by or in connection with the processor or other such instruction execution system, apparatus, or device. Although the processor has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system is implemented in hardware, the system can be implemented with any or a combination of the following technologies, which are each well known in the art: a discrete-logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

We claim:

1. A method for detecting intrusions to a set of assets comprising a list of assets identifications, a list of wallet identifications, a register of asset-wallet associations, a bitcoin blockchain, wherein each asset holds a wallet, and wherein wallet identifications include bitcoin live unspent transactions, the method consisting in the steps of:
at the publication of every new block of the bitcoin blockchain, checking if one of the live unspent transactions is missing from the list of live unspent transactions included in the new block of the blockchain, and
determining whether an intrusion has happened based on the check.

2. The method of claim 1 further comprising the step of retrieving the asset-wallet pair associated with the missing live unspent transaction and returning the asset information.

3. The method of claim 1 wherein the asset is one of a computer desktop, a mobile phone, a tablet, a network device, a virtual machine, or a mailbox.

4. A method for detecting intrusions in a set of assets, comprising a list of assets and a pre-specified amount of coins, the method consisting in the steps of:
generating one wallet per asset, the wallet containing an unspent transaction for the pre-specified amount of coins and the private key associated with this unspent transaction;
placing each wallet in a different asset and registering the asset-wallet association;
at the publication of every new block, checking if one of any of the registered unspent transaction is missing from the block's list of unspent transactions; and
determining an intrusion has happened based on the check and returning the identification of the asset associated with this wallet in the asset-wallet association register.

5. A method for detecting intrusions in a set of assets comprising a list of N asset identifications, a list of N wallet identifications, a list of unspent transactions that are included in the wallets, a register of asset-wallet associations, wherein each asset holds a wallet, each wallet holds F unspent transactions and no two wallets hold exactly the same unspent transactions, the method consisting in the steps of:
at the publication of every new block, checking if one of the live unspent transactions is missing from the list of unspent transactions included in the block, and
determining an intrusion has happened based on the check and returning the identification of the asset associated with this wallet in the asset-wallet association register.

6. The method of claim 5 wherein the check is verified if every unspent transaction in a wallet is in the list of missing unspent transactions.
